(19) United States
(12) Patent Application Publication
(10) Pub. No.: US 2018/0319052 A1
(43) Pub. Date: Nov. 8, 2018

(54) MOLDING DEVICE HAVING HEATING AND COOLING FUNCTIONS

(71) Applicant: POU CHEN CORPORATION, Chang Hwa Hsien (TW)

(72) Inventors: Hsiang-Yu HUANG, Taichung City (TW); Shih-Chia LIN, Yuanlin City (TW); Hung-Wu HSIEH, Xizhou Township (TW); Ju-Cheng CHEN, Tainan City (TW); Tsung-Wei KUO, Changhua City (TW)

(21) Appl. No.: 15/968,538

(22) Filed: May 1, 2018

(30) Foreign Application Priority Data
May 3, 2017 (TW) 106114626

(51) Int. Cl. B29C 43/58; B29C 43/36; B29C 43/02; B29C 43/52; B29C 33/04

(52) U.S. Cl. CPC B29C 43/58; B29C 43/36; B29K 2023/083; B29C 43/52; B29C 33/046; B29C 43/02

(57) ABSTRACT

A molding device includes a lower die core assembly including a porous lower die core unit, an upper die core assembly including a porous upper die core, a heating assembly for heating the lower die core unit and the upper die core, and a control assembly operable to control temperature of an assembly of the lower die core unit and the upper die core to be direct proportional to a distance by which the upper die core is moved downwardly from a compression starting position where the upper die core comes into contact with the lower die core unit. The control assembly is further operable to control one of a heated gas and a cooled gas to be introduced into and discharged from the upper and lower mold core assemblies at different rates.

### CROSS-REFERENCE TO RELATED APPLICATION

This application claims priority of Taiwanese Invention Patent Application No. 106114626, filed on May 3, 2017.

### FIELD

The disclosure relates to a molding device, and more particularly to a molding device having heating and cooling functions for heating or cooling a raw material.

### BACKGROUND

Ethylene-vinyl acetate (EVA) foam material or thermoplastic polyurethane (TPU) foam material are widely used in making insole or outsole of shoes because of their superior cushion, shock-absorbing, heat insulation, moistureproof, chemical resistant properties. EVA and TPU are also nontoxic and non-water absorbing, which is quite environment friendly.

Referring to FIG. 1, a conventional molding device 1 disclosed by Taiwanese Invention Patent No. 576329 includes a heating mold assembly 11, a cooling mold assembly 12 and a conveying unit 13. The heating mold assembly 11 includes a lower mold 111, and an upper mold 113 that is removably connected to the lower mold 111 to cooperate with the lower mold 111 to define a mold cavity 112 therebetween. The heating mold assembly 11 further includes a plurality of heating members 114, such as resistive heater, that are disposed in the lower and upper molds 111, 113. The cooling mold assembly 12 includes a lower mold 121, an upper mold 123 that is removably connected to the lower mold 121 to define a mold cavity 122 therebetween. The cooling mold assembly 12 further includes a plurality of cooling passages 124 that are formed in the lower mold 121 and the upper mold 123.

When the heating members 114 are heated up, the lower and upper molds 111, 113 are also heated up via thermal conduction to heat up a molding material received in the mold cavity 112. Afterwards, the conveying unit 13 is operated to move the molding material from the mold cavity 112 to the mold cavity 122, followed by covering the mold cavity 122 with the upper mold 123. A cooling liquid is then fed into the cooling passages 124 to cool down the molding material in the mold cavity 122.

The heating efficiency of the lower and upper molds 111, 113 affects heating uniformity and heating cycle time of the molding material, and therefore the quality of a final product. While the resistive heating members 114 have a rather quick heating speed, which may be around 1 to 3° C. per second, it is quite difficult to precisely control the temperature of the resistive heating members 114 within a desirable range, thereby resulting in difficulties in the temperature control of the lower and upper molds 111, 113, which might reduce the service life of the lower and upper molds 111, 113. Moreover, since the molding material is softened after being heated, a user needs to wait for the molding material to slightly cool down in the mold cavity 112 before moving the molding material, which is time-consuming. In addition, the cooling effect is better in the regions where the cooling passages 124 pass through. Therefore, it is desirable to increase cooling uniformity of the cooling mold assembly 12.

### SUMMARY

Therefore, an object of the disclosure is to provide a molding device that can alleviate at least one of the drawbacks of the prior art.

According to the aspect of the present disclosure, a molding device is adapted to heat or cool a raw material. The molding device includes a lower die core assembly, an upper die core assembly, a heating assembly and a control assembly.

The lower die core assembly includes a lower die core unit that defines a mold cavity. The lower die core unit is made of a porous material, and includes at least one internal loop that is adapted for one of a heated gas and a cooled gas to pass therethrough. The internal loop includes an inlet and an outlet. The upper die core assembly is detachably connected to the lower die core assembly, and includes an upper die core that covers the mold cavity. The upper die core is made of a porous material, and includes an upper die core passage that is adapted for one of the heated gas and the cooled gas to pass therethrough. The upper die core passage includes an inlet and an outlet. The heating assembly includes a lower heating member that is mounted to the lower die core assembly for heating the lower die core unit, and an upper heating member that is mounted to the upper die core assembly for heating the upper die core. The control assembly is connected to the lower die core assembly and the upper die core assembly.

When the upper die core of the upper die core assembly comes into contact with the lower die core unit of the lower die core assembly at a compression starting position, the upper die core of the upper die core assembly is operable to move toward the lower die core unit by a compressing distance (D) to cover the mold cavity.

The control assembly is operable to control temperature of an assembly of the lower die core unit and the upper die core to be directly proportional to a distance by which the upper die core of the upper die core assembly is moved downwardly from the compression starting position. The control assembly is further operable to control the one of the heated gas and the cooled gas to be introduced into and discharged from an assembly of the upper and lower mold core assemblies in a first period and a second period.

In the first period, one of the heated gas and the cooled gas is introduced into the internal loop and the upper die core passage through the inlets of the internal loop and the upper die core passage, and is discharged from the internal loop and the upper dir core passage through the outlets of the internal loop and the upper die core passage.

In the second period, one of the heated gas and the cooled gas is introduced into the internal loop and the upper die core passage through the inlets of the internal loop and the upper die core passage, and is discharged from pores of the lower die core unit and the upper die core.

### BRIEF DESCRIPTION OF THE DRAWINGS

Other features and advantages of the disclosure will become apparent in the following detailed description of the embodiment with reference to the accompanying drawings, of which:

FIG. 1 is a schematic view of a conventional molding device according to Taiwanese Invention Patent No. 576329;

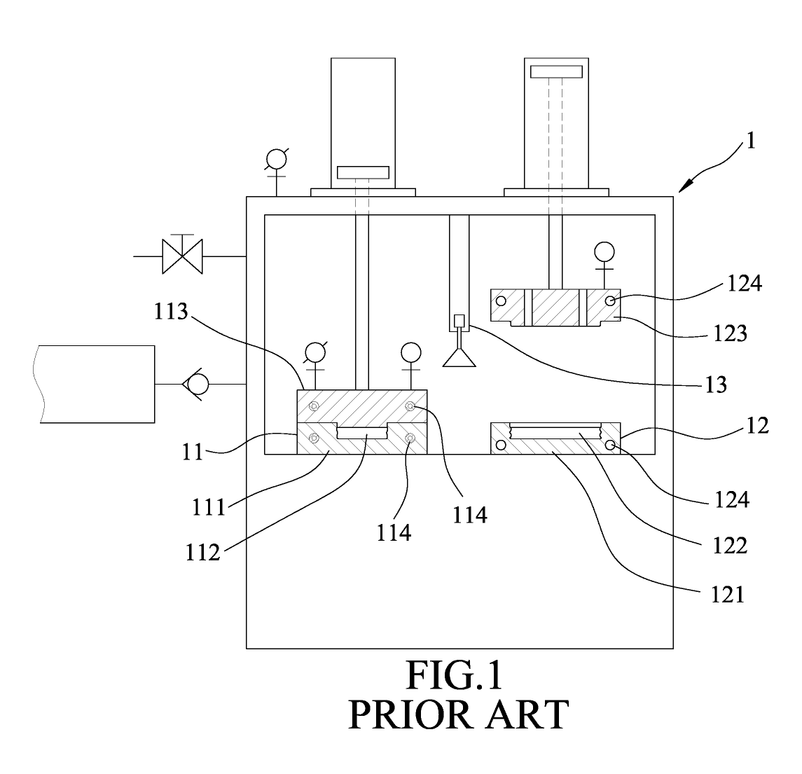

FIG. 2 is a sectional view of an embodiment of a molding device according to the present disclosure, illustrating that an upper die core of an upper die core assembly of the embodiment is at a compression starting position relative to a lower die core assembly;

FIG. 3 is a sectional view of the embodiment, illustrating that the lower die core assembly is in a closed state and the upper die core assembly is in a lowered state to cover a mold cavity of the lower die core assembly;

FIG. 4 is a schematic top view of the lower die core assembly of the embodiment, showing the lower die core assembly in the closed state;

FIG. 5 is a block diagram showing a control assembly of the embodiment;

FIG. 6 is a sectional view of the embodiment taken along line VI-VI of FIG. 3;

FIG. 7 is a sectional view of the embodiment taken along line VII-VII of FIG. 3;

FIG. 8 is a partly exploded sectional view of the embodiment, showing the lower die core assembly in an open state and the upper die core assembly in a lifted state;

FIG. 9 is a schematic top view of the lower die core assembly of the embodiment, showing the lower die core assembly in the open state;

FIG. 10 is a diagram showing the temperature of an assembly of a lower die core unit and an upper die core of the embodiment being controlled to be directly proportional to a distance by which the upper die core is moved downwardly from the compression starting position;

FIG. 11 is a diagram showing heating rate of a first period and a second period; and

FIG. 12 is a diagram showing heating rate of the first period, the second period and a third period.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

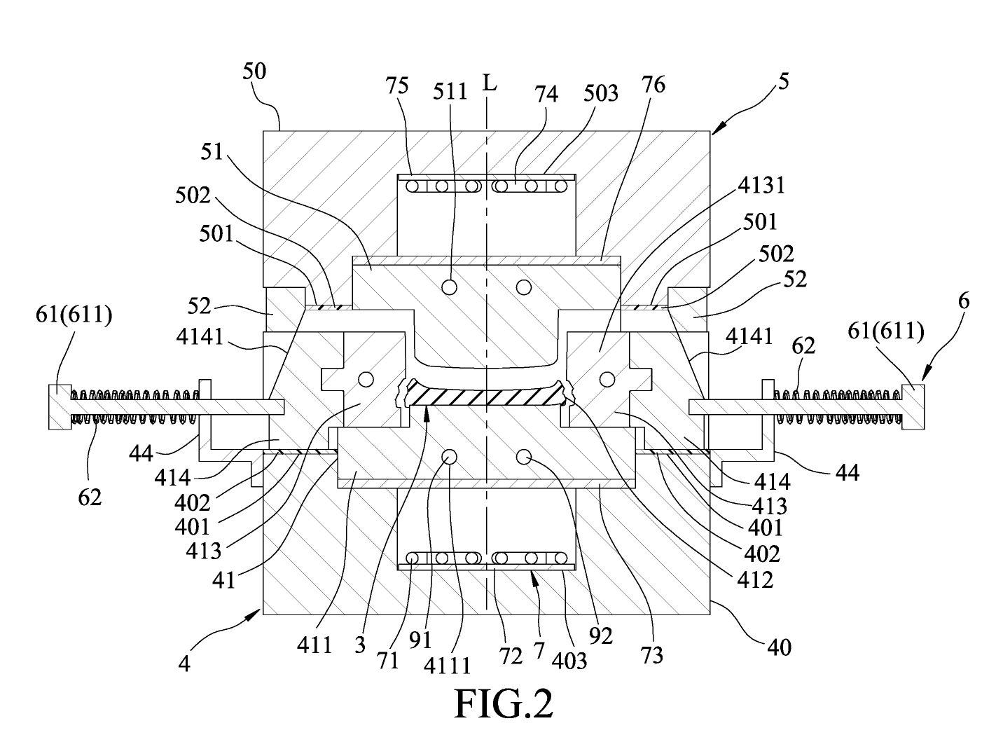

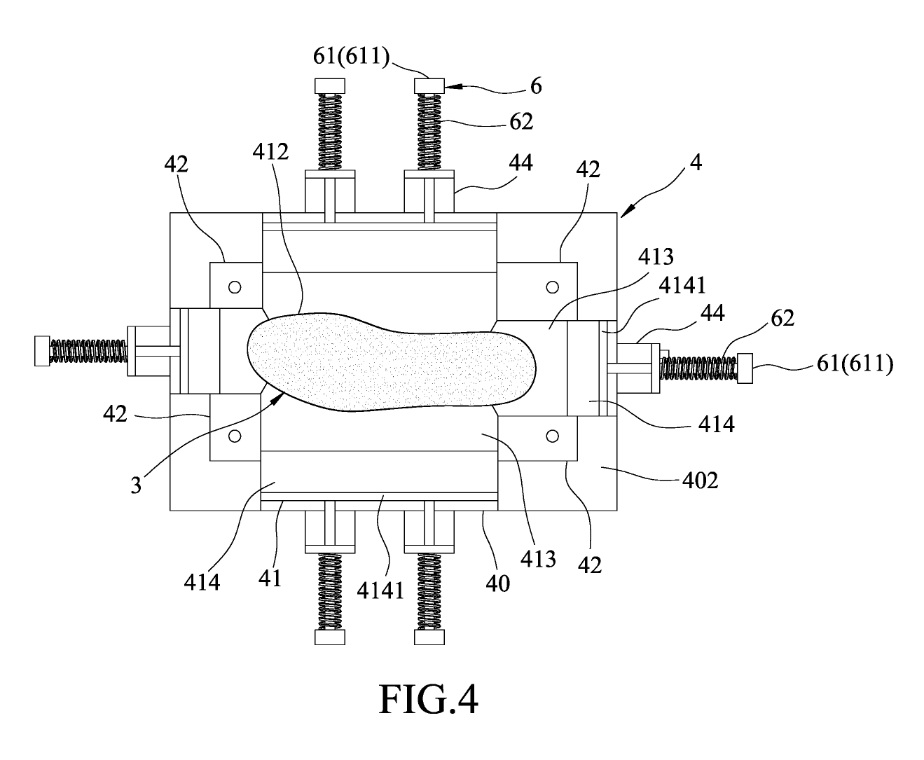

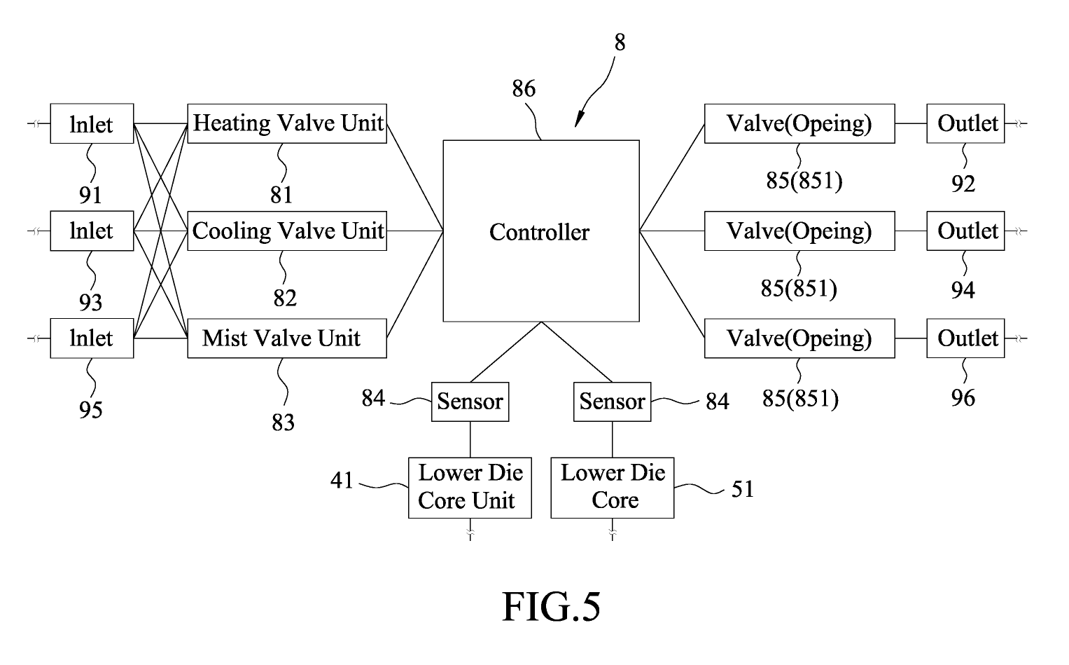

Referring to FIGS. 2 to 5, an embodiment of a molding device is adapted to heat or cool a raw material 3 to form a product, such as a shoe sole. The molding device includes a lower die core assembly 4, an upper die core assembly 5, a biasing assembly 6, a heating assembly 7 and a control assembly 8.

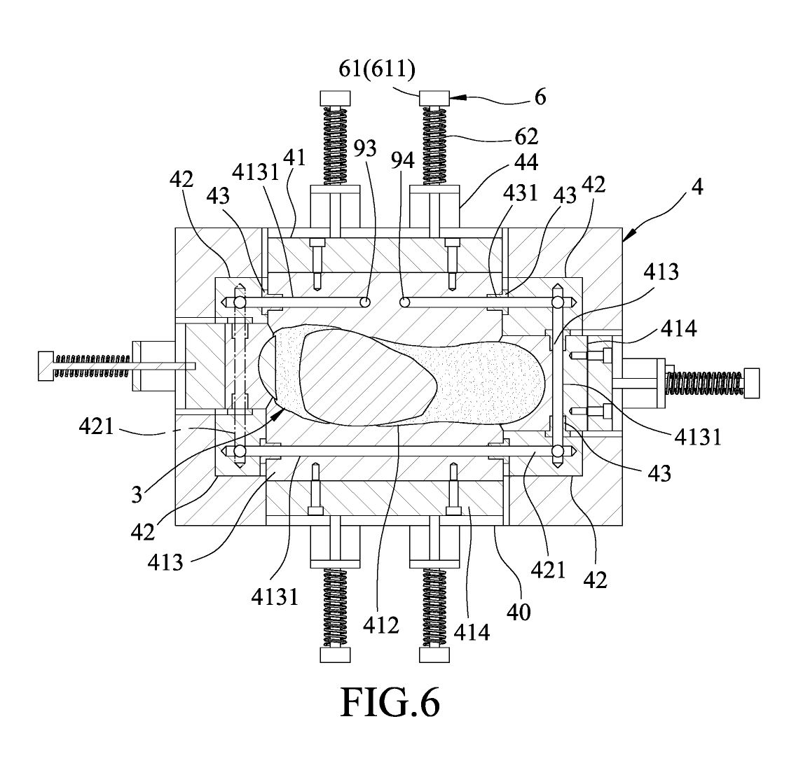

The lower die core assembly 4 includes a lower mold seat 40, a lower die core unit 41, at least two positioning blocks 42, a plurality of sealing members 43 (see FIG. 6), and three pairs of brackets 44. In this embodiment, the lower die core assembly 4 includes four of the positioning blocks 42.

The lower mold seat 40 is made of steel, and includes an upward facing surface 401 that faces the upper die core assembly 5, a lower insulating layer 402 that is formed on the upward facing surface 401, and a lower mounting portion 403 that is downwardly concaved from the upward facing surface 401 along a vertical central axis (L).

The lower die core assembly 41 is made of porous copper, and is made by one of powder metallurgy and 3D printing. The lower die core unit 41 includes a mold plate 411 that is mounted in the lower mounting portion 403 of the lower mold seat 40, at least two lower die cores 413 that are movably disposed on the mold plate 411, that surround the central axis (L) and that cooperate with the mold plate 411 to define a mold cavity 412, and at least two sliding blocks 414 that are respectively connected to the lower die cores 413 such that each of the sliding blocks 414 is co-movable with the respective one of the lower die cores 413 on the lower mold seat 40. In this embodiment, the lower die core unit 41 includes four of the lower die cores 413 and four of the sliding blocks 414. The mold plate 411 includes a mold plate passage 4111. Each of the lower die cores 413 includes a lower die core passage 4131 and is disposed between adjacent two of the positioning blocks 42. Each of the sliding blocks 414 has an engaging portion 4141 that is formed at an upper end of the sliding block 414. Each of the positioning blocks 42 includes a positioning block passage 421 (see FIG. 6). Each of the sealing members 43 includes a connecting passage 431 and is sealingly disposed between a corresponding one of the lower die cores 413 and a corresponding one of the positioning blocks 42. In this embodiment, one pair of the brackets 44 are respectively mounted to opposite front and rear sides of the lower mold seat 40, the remaining two pairs of the brackets 44 are respectively mounted to opposite left and right sides of the lower mold seat 40.

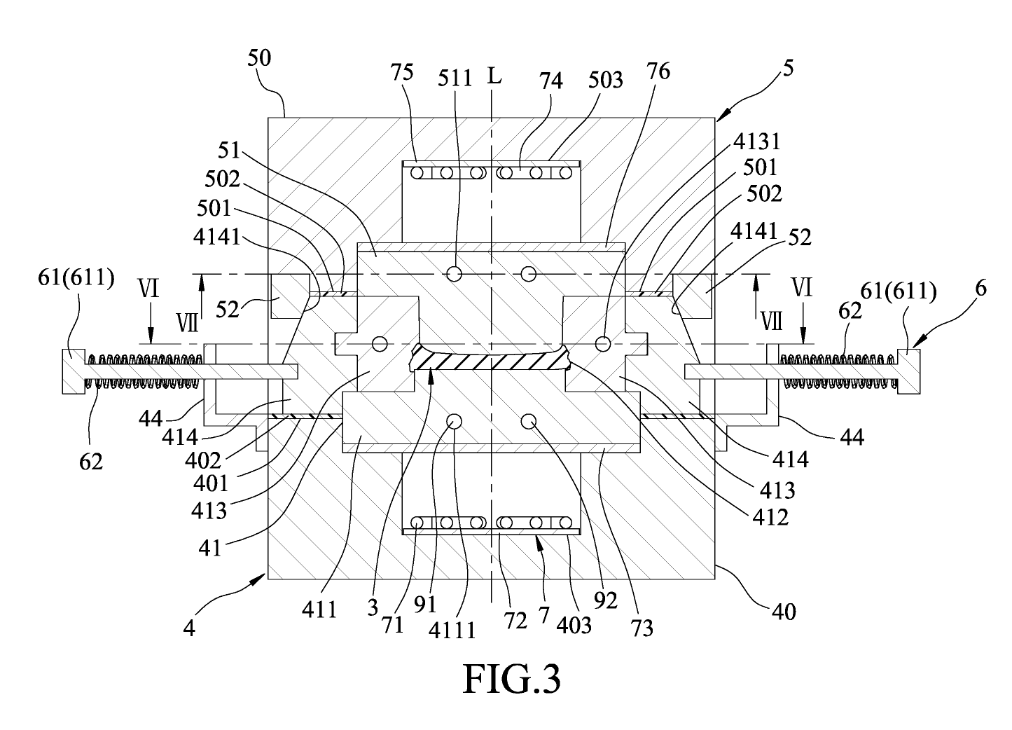

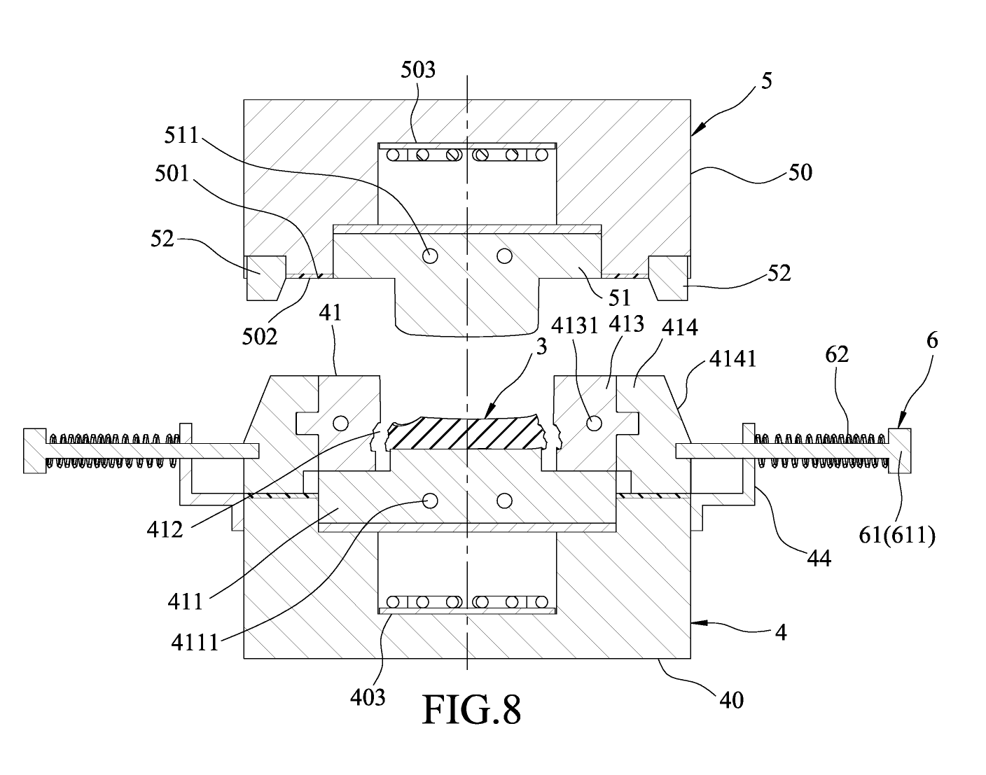

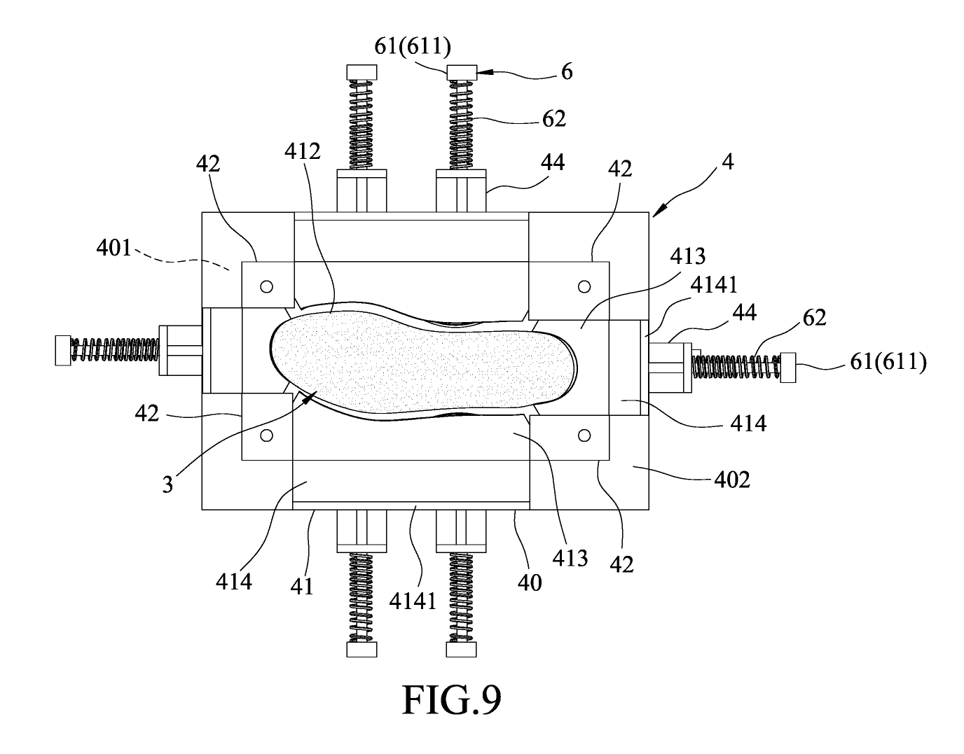

The lower die core assembly 4 is convertible between a closed state (see FIGS. 3, 4 and 6), where the lower die core passage 4131 of each of the lower die cores 413 is fluidly communicated with the positioning block passages 421 of the adjacent two of the positioning blocks 42, and an open state (see FIGS. 8 and 9), where the lower die cores 413 are spaced apart from each other, and the lower die core passage 4131 of each of the lower die cores 413 is not fluidly communicated with the positioning block passages 421 of the adjacent two of the positioning blocks 42. When the lower die core assembly 4 is in the closed state, the connecting passage 431 of each of the sealing members 43 is fluidly communicated with the lower die core passage 4131 of the corresponding one of the lower die cores 413 and the positioning block passage 421 of the corresponding one of the positioning blocks 42. The mold plate passage 4111 (i.e., a first internal loop formed in the lower die core unit 41) includes an inlet 91 and at least one outlet 92, and is adapted for one of a heated gas and a cooled gas to pass therethrough. The lower die core passages 4131 of the lower die cores 413 and the positioning block passages 421 of the positioning blocks 42 cooperatively form a second internal loop, which includes an inlet 93 and at least one outlet 94.

The upper die core assembly 5 is detachably connected to the lower die core assembly 4, and includes an upper mold seat 50, an upper die core 51 and at least two engaging members 52. In this embodiment, the upper die core assembly 5 includes four of the engaging members 52.

The upper mold seat 50 is made of steel, and includes an downward facing surface 501 that faces the lower die core assembly 4, an upper insulating layer 502 that is formed on the downward facing surface 501, and an upper mounting portion 503 that is upwardly concaved from the downward facing surface 501 along the central axis (L).

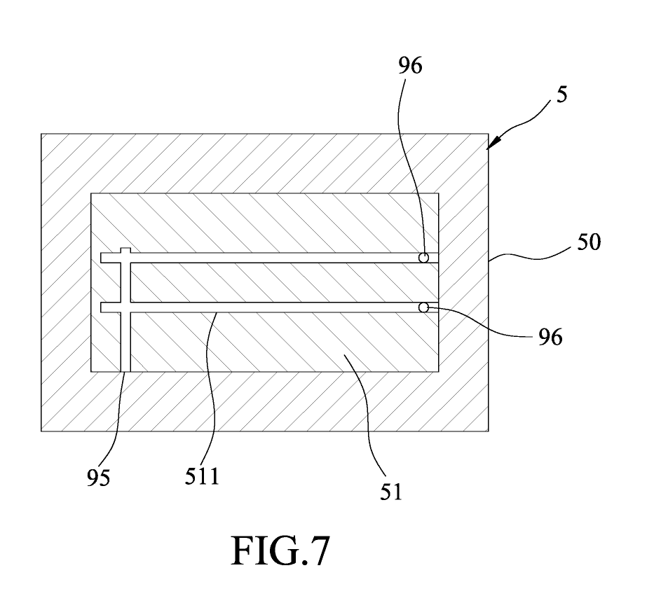

The upper die core 51 is disposed on the upper mold seat 50. When the upper die core 51 of the upper die core assembly 5 comes into contact with the lower die core unit 41 of the lower die core assembly 4 at a compression starting position (see FIG. 2), the upper die core 51 of the upper die core assembly 5 is operable to move toward the lower die core unit 41 by a compressing distance (D) to cover the mold cavity 412 (see FIGS. 2 and 3). The upper die core 51 is made of porous copper, is made by one of powder metallurgy and 3D printing, and includes an upper die core passage 511 that is adapted for one of the heated gas and the cooled gas to pass therethrough and that includes an inlet 95 and an outlet 96 (see FIG. 7). The engaging members 52 are mounted to the upper mold seat 50 and that respectively correspond in position to the engaging portions 4141 of the sliding blocks 414.

The upper die core assembly 5 is convertible between a lifted state, where the engaging members 52 are spaced apart from the engaging portions 4141 of the sliding blocks 414 (i.e., the upper die core assembly 5 is spaced apart from the lower die core assembly 4), and a lowered state, where the upper die core assembly 5 is connected to the lower die core assembly 4. Specifically, when the upper die core assembly 5 is converted from the lifted state into the lowered state, the engaging members 52 move to respectively contact and push the engaging portions 4141 of the sliding blocks 414 so as to move the sliding blocks 414 and the lower die cores 413 toward the central axis (L) such that the lower die core assembly 4 is converted into the closed state to compress the raw material 3 in the mold cavity 412.

The biasing assembly 6 includes a plurality of sliding members 61 and a plurality of resilient members 62. Specifically, in this embodiment, the number of the sliding members 61 is six and the number of the resilient members 62 is also six. Each of the sliding members 61 has a head portion 611, movably extends through a corresponding one of the brackets 44 of the lower die core unit 41, and is fixedly connected to a corresponding one of the sliding blocks 414. Each of the resilient members 62 is configured as a compression spring and is disposed between the head portion 611 of a respective one of the sliding members 61 and the corresponding one of the brackets 44, and continuously exerts a biasing force to push the corresponding one of the sliding blocks 414 connected to the corresponding one of the sliding members 61 away from the central axis (L). It is worth mentioning that the numbers of the sliding members 61 and the resilient members 62 are not limited to six, and may be changed according to practical requirements.

The heating assembly includes a lower heating member 71 that is mounted into the lower mounting portion 403 of the lower mold seat 40 of the lower die core assembly 4 and that is a high-frequency coil for heating the lower die core unit 41, a lower shielding layer 72 that is disposed between the lower mold seat 40 and the lower heating member 71, a lower magnetic conducting layer 73 that is in contact with the lower die core unit 41 and that is located within the electromagnetic induction range of the lower heating member 71, an upper heating member 74 that is mounted into the upper mounting portion 503 of the upper mold seat 50 of the upper die core assembly 5 and that is a high-frequency coil for heating the upper die core 51, an upper shielding layer 75 that is disposed between the upper mold seat 50 and the upper heating member 74, and an upper magnetic conducting layer 76 that is in contact with the upper die core 51 and that is located within the electromagnetic induction range of the upper heating member 74.

Referring to FIGS. 3 to 5, the control assembly 8 is connected to the lower die core assembly 4 and the upper die core assembly 5, and includes a heating valve unit 81 that is connected to the inlet 91 of the first internal loop, the inlet 93 of the second internal loop and the inlet 95 of the upper die core passage 511 to introduce the heated gas into the first internal loop, the second internal loop and the upper die core passage 511. The control assembly 8 further includes a cooling valve unit 82 that is connected to the inlet 91 of the first internal loop, the inlet 93 of the second internal loop and the inlet 95 of the upper die core passage 511 to introduce the cooled gas into the first internal loop, the second internal loop and the upper die core passage 511. The control assembly 8 further includes a mist valve unit 83 that is connected to the inlet 91 of the first internal loop, the inlet 93 of the second internal loop and the inlet 95 of the upper die core passage 511 to introduce a low temperature mist into the first internal loop, the second internal loop and the upper die core passage 511. The control assembly 8 further includes two sensors 84 that are respectively connected to the lower die core unit 41 and the upper die core 51 and that respectively detect the temperatures of the lower die core unit 41 and the upper die core 51. The control assembly 8 further includes a plurality of valves 85 that are respectively connected to the outlet 92 of the first internal loop, the outlet 94 of the second internal loop and the outlet 96 of the upper die core passage 511. Each of the valves 85 includes an opening 851. The control assembly 8 further includes a controller 86 that is electrically connected to the heating valve unit 81, the cooling valve unit 82, the mist valve unit 83, the sensors 84 and the valves 85. The controller 86 is operable to control the openings 851 of the valves 85 to open or close. The controller 86 is further operable to control temperature of an assembly of the lower die core unit 41 and the upper die core 51 to be direct proportional to a distance by which the upper die core 51 of the upper die core assembly 5 is moved downwardly from the compression starting position. The controller 86 is further operable to control the one of the heated gas and the cooled gas to be introduced into and discharged from an assembly of the upper and lower mold core assemblies 5, 4 in a first period (t1) and a second period (t2). The controller 86 is further operable to control the gas flow of the cooled gas and the low temperature mist in a third period (t3). In this embodiment, temperature of the low temperature mist is lower than that of the cooled gas.

In the first period (t1), one of the heated gas and the cooled gas is introduced into the first internal loop, the second internal loop and the upper die core passage 511 through the inlets 91, 93, 95, and the openings 851 of the valves 85 are opened so as to allow the one of the heated gas and the cooled gas to be discharged from the first internal loop, the second internal loop and the upper die core passage 511 through the outlets 92, 94, 96.

In the second period (t2), one of the heated gas and the cooled gas is introduced into the first internal loop, the second internal loop and the upper die core passage 511 through the inlets 91, 93, 95, and the openings 851 of the valves 85 are closed so as to allow the one of the heated gas and the cooled gas to be discharged from pores of the lower die core unit 41 and the upper die core 51.

In the third period (t3), the cooled gas and the low temperature mist are introduced into the first internal loop, the second internal loop and the upper die core passage 511 through the inlets 91, 93, 95, and the openings 851 of the valves 85 are closed so as to allow the cooled gas and the low temperature mist to be discharged from the pores of the lower die core unit 41 and the upper die core 51.

Referring to FIGS. 2 to 4, 6, 8 and 9, initially, the upper die core assembly 5 is in the lifted state and the lower die core assembly 4 is in the open state (see FIG. 8), allowing an unmolded raw material (not shown) to be placed into the mold cavity 412. Afterwards, the upper die core assembly 5 is moved toward the lower die core assembly 4. Referring to FIG. 2, when the upper die core assembly 5 comes into contact with the lower die core assembly 4, the upper die core 51 of the upper die core assembly 5 is at the compression starting position, where the engaging members 52 are respectively in contact with the engaging portions 4141 of the sliding blocks 414. Then, the upper die core assembly 5 is further moved toward the lower die core assembly 4, and the engaging members 52 respectively abut against and push the engaging portions 4141 of the sliding blocks 414, allowing the sliding blocks 414 and the lower die cores 413 to overcome the biasing force of the resilient members 62 and to move toward the central axis (L) so as to compress the foaming material 3. When the upper die core assembly 5 is converted into the lowered state, the lower die core assembly 4 is converted into the closed state (see FIGS. 3, 4 and 6).

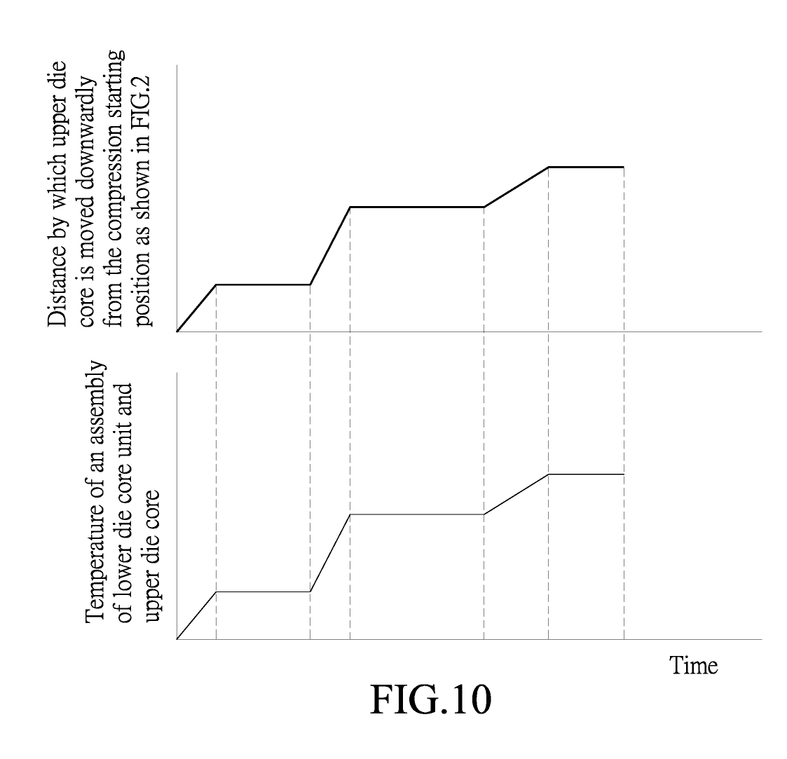

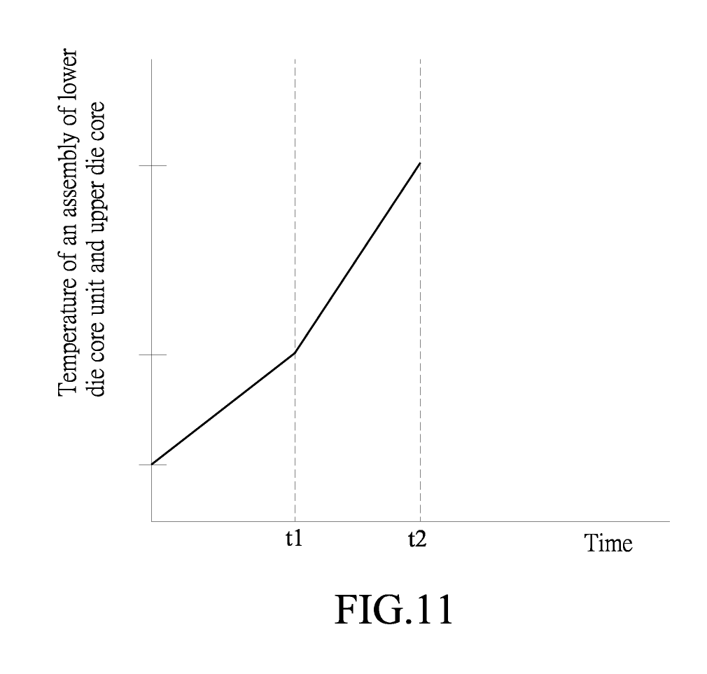

During the process of converting the upper die core assembly 5 from the lifted state to the lowered state, the controller 86 may be operated to control the lower heating member 71 and the upper heating member 74 to generate heat to respectively heat up the lower die core unit 41 and the upper die core 51. In the meantime, the heated gas is introduced into the first internal loop, the second internal loop and the upper die core passage 511 through the inlets 91, 93, 95. During the heating and molding process, the sensors 84 monitor the temperatures of the lower die core unit 41 and the upper die core 51 so as to determine which one of the first and second periods (t1, t2) should be carried out. Referring to FIG. 11, the first period (t1) is a slower heating process compared to the second period (t2) due to the fact that, in the first period (t1), the heated gas is discharged from the first internal loop, the second internal loop and the upper die core passage 511 through the outlets 92, 94, 96. The temperature of the assembly of the lower die core unit 41 and the upper die core 51 is controlled to be directly proportional to the distance by which the upper die core 51 of the upper die core assembly 5 is moved downwardly from the compression starting position to ensure a more uniform heating of the raw material 3. An example of temperature control is shown in FIG. 10.

It is worth mentioning that, although the lower mold seat 40 and the upper mold seat 50 may be made of magnetic conductive material, such as steel, the lower shielding layer 72 and the upper shielding layer 75 can prevent eddy current from being inducted in the lower mold seat 40 and the upper mold seat 50 or to reduce the eddy current induced in the lower mold seat 40 and the upper mold seat 50. Moreover, the lower insulating layer 402 and the upper insulating layer 502 can prevent electric arc from occurring between the lower die core assembly 4 and the upper die core assembly 5 when the upward facing surface 401 and the downward facing surface 501 are moved close to each other.

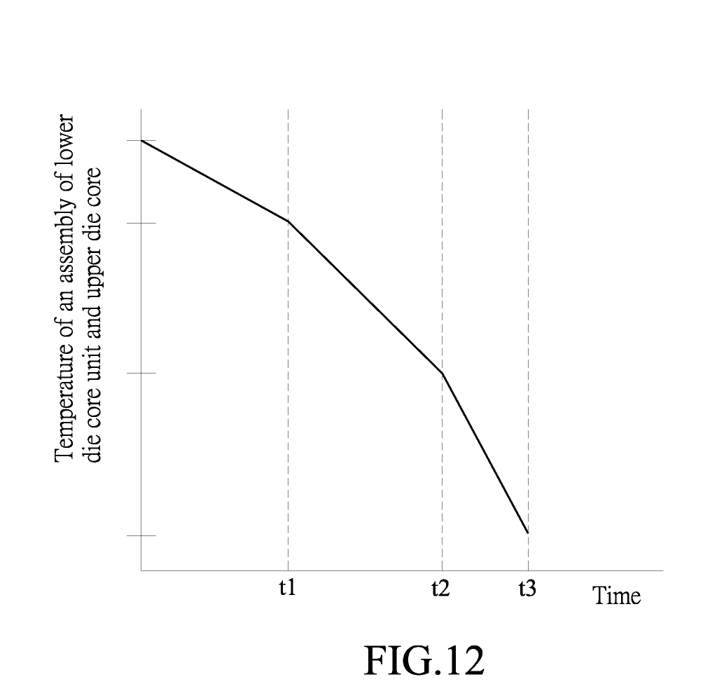

After the heating and molding process, the cooled gas or the cooled gas combined with the low temperature mist is introduced into the first internal loop, the second internal loop and the upper die core passage 511 through the inlets 91, 93, 95 for cooling down the molded raw material 3 to a temperature lower than the glass transition temperature of the molded raw material 3. According to the practical cooling requirements, either one of the first, second and third periods (t1, t2, t3) can be carried out. Referring to FIG. 12, since there is the low temperature mist involved in the third period (t3), the third period (t3) is therefore the fastest cooling period.

Referring to FIGS. 8 and 9, after cooling of the raw material 3, the upper die core assembly 5 is moved to the lifted state, where the engaging members 52 are spaced apart from the engaging portions 4141 of the sliding blocks 414 of the lower die core assembly 4, allowing the biasing force of the resilient members 62 to push the sliding blocks 414 and the lower die cores 413 to move away from the central axis (L), thereby expanding the mold cavity 412 to allow an automated apparatus (not shown) to remove the product from the mold cavity 412.

The advantages of the molding device according to the present disclosure are summarized below.

The lower die core unit 41 defines the mold cavity 412 that can be expanded or contracted, facilitating the raw material 3 to be put in and removed from the mold cavity 412 and providing uniform compression of the raw material 3. The quality of the product can be further improved by further cooperation with the automated apparatus for removing the raw material 3.

Based on the sizes of the raw material 3, each of the mold plate 411 and the lower die cores 413 may be replaced with a new one of different size without changing the lower mold seat 40 and the biasing assembly 6.

The porous lower die core unit 41, the porous upper die core 51 and the abovementioned passages and internal loops allow the heated gas, the cooled gas or the low temperature mist to flow therethrough, so as to uniformly heat or cool the raw material 3 in the mold cavity 412. In addition, the raw material 3 can be heated or cooled in the mold cavity 412 without the necessity of transferring to another mold for cooling, thereby saving process time and ensuring the quality of the product.

The periods (t1, t2, t3) achieve a stepped heating or a steeped cooling, thereby alleviating damages brought by rapid heating or cooling. For example, rapid cooling might cause warpage of the product, and rapid heating might cause thermal fatigue to the lower die core assembly 4 and the upper die core assembly 5.

In the description above, for the purposes of explanation, numerous specific details have been set forth in order to provide a thorough understanding of the embodiment. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects, and that one or more features or specific details from one embodiment may be practiced together with one or more features or specific details from another embodiment, where appropriate, in the practice of the disclosure.

While the disclosure has been described in connection with what are considered the exemplary embodiment, it is understood that this disclosure is not limited to the disclosed embodiment but is intended to cover various arrangements included within the spirit and scope of the broadest interpretation so as to encompass all such modifications and equivalent arrangements.

What is claimed is:

1. A molding device adapted to heat or cool a raw material, said molding device comprising:
a lower die core assembly including a lower die core unit that defines a mold cavity, said lower die core unit being made of a porous material and including at least one internal loop adapted for one of a heated gas and a cooled gas to pass therethrough, said internal loop including an inlet and an outlet;
an upper die core assembly detachably connected to said lower die core assembly and including an upper die core that covers the mold cavity, said upper die core being made of a porous material and including an upper die core passage adapted for one of the heated gas and the cooled gas to pass therethrough, said upper die core passage including an inlet and an outlet;
a heating assembly including a lower heating member that is mounted to said lower die core assembly for heating said lower die core unit, and an upper heating member that is mounted to said upper die core assembly for heating said upper die core; and
a control assembly connected to said lower die core assembly and said upper die core assembly,
wherein, when said upper die core of said upper die core assembly comes into contact with said lower die core unit of said lower die core assembly at a compression starting position, said upper die core of said upper die core assembly is operable to move toward said lower die core unit by a compressing distance to cover said mold cavity;
wherein said control assembly is operable to control temperature of an assembly of said lower die core unit and said upper die core to be directly proportional to a distance by which said upper die core of said upper die core assembly is moved downwardly from the compression starting position, and is operable to control the one of the heated gas and the cooled gas to be introduced into and discharged from an assembly of said upper and lower mold core assemblies in a first period and a second period;
wherein, in the first period, one of the heated gas and the cooled gas is introduced into said internal loop and said upper die core passage through said inlets of said internal loop and said upper die core passage and is discharged from said internal loop and said upper die core passage through said outlets of said internal loop and said upper die core passage; and
wherein, in the second period, one of the heated gas and the cooled gas is introduced into said internal loop and said upper die core passage through said inlets of said internal loop and said upper die core passage and is discharged from pores of said lower die core unit and said upper die core.

2. The molding device as claimed in claim 1, wherein said control assembly includes
a heating valve unit that is connected to said inlets of said internal loop and said upper die core passage and that is operable to introduce the heated gas into said internal loop and said upper die core passage,
a cooling valve unit that is connected to said inlets of said internal loop and said upper die core passage and that is operable to introduce the cooled gas into said internal loop and said upper die core passage,
two sensors that are respectively connected to said lower die core unit and said upper die core and that respectively detect the temperatures of said lower die core unit and said upper die core,
at least two valves that are respectively connected to said outlets of said lower die core unit and said upper die core, each of said valves including an opening, and
a controller that is electrically connected to said heating valve unit, said cooling valve unit, said sensors and said valves, and that is operable to control said openings of said valves to open or close.

3. The molding device as claimed in claim 2, wherein:
said control assembly further includes a mist valve unit that is connected to said inlets of said internal loop and said upper die core passage and that is operable to introduce a low temperature mist into said internal loop and said upper die core passage;
said controller is further electrically connected to said mist valve unit and is further operable to control the gas flow of the cooled gas and the low temperature mist in said lower die core assembly and said upper die core assembly in a third period; and
in the third period, the cooled gas and the low temperature mist are introduced into said internal loop and said upper die core passage through said inlets of said internal loop and said upper die core passage and is discharged from said pores of said lower die core unit and said upper die core, temperature of the low temperature mist being lower than that of the cooled gas.

4. The molding device as claimed in claim 1, wherein said lower die core assembly further includes a lower mold seat on which said lower die core unit is disposed, said upper die core assembly further including an upper mold seat on which said upper die core is disposed, said lower mold seat and said upper mold seat being made of steel, said lower heating member being a high-frequency coil and being mounted to said lower mold seat, said upper heating member being a high-frequency coil and being mounted to said upper mold seat.

5. The molding device as claimed in claim 4, wherein said lower die core unit and said upper die core are made of copper, said heating assembly further including a lower magnetic conducting layer that is in contact with said lower die core unit and that is located within the electromagnetic induction range of said lower heating member, said heating assembly further including an upper magnetic conducting layer that is in contact with said upper die core and that is located within the electromagnetic induction range of said upper heating member.

6. The molding device as claimed in claim 4, wherein said heating assembly further includes a lower shielding layer that is disposed between said lower mold seat and said lower heating member, and an upper shielding layer that is disposed between said upper mold seat and said upper heating member.

7. The molding device as claimed in claim 1, wherein said lower die core unit includes a mold plate that is mounted to said lower mold seat, and at least two lower die cores that surround a central axis, said lower die core assembly further including at least two positioning blocks that are disposed on said mold plate of said lower die core unit, each of said positioning blocks including a positioning block passage, each of said lower die cores including a lower die core passage and being disposed between said positioning blocks, said mold plate including a mold plate passage, said lower die core assembly being convertible between a closed state, where said lower die core passage of each of said lower die cores is fluidly communicated with said positioning block passages of said positioning blocks, and an open state, where said lower die cores are spaced apart from each other, and said lower die core passage of each of said lower die cores is not fluidly communicated with said positioning block passages of said positioning blocks.

8. The molding device as claimed in claim 7, wherein:
said lower die core unit of said lower die core assembly further includes at least two sliding blocks that are respectively connected to said lower die cores, each of said sliding blocks having an engaging portion that is formed at an upper end of said sliding block;
said upper die core assembly further includes at least two engaging members that are mounted to said upper mold seat;
said upper die core assembly is convertible between a lifted state, where said engaging members are spaced apart from said engaging portions of said sliding blocks, and a lowered state, where said upper die core assembly is connected to said lower die core assembly;
when said upper die core assembly is converted from the lifted state into the lowered state, said engaging members move to respectively contact and push said engaging portions of said sliding blocks so as to move said sliding blocks and said lower die cores toward the central axis such that said lower die core assembly is converted into the closed state.

9. The molding device as claimed in claim 8, wherein, when said upper die core of said upper die core assembly is at the compression starting position, said engaging members are respectively in contact with said engaging portions of said sliding blocks.

10. The molding device as claimed in claim 8, further comprising a biasing assembly that includes a plurality of sliding members and a plurality of resilient members, each of said sliding members movably extending into said lower mold seat and being fixedly connected to a corresponding one of said sliding blocks, each of said resilient members being disposed between a respective one of said sliding members and said lower mold seat and pushing a corresponding one of said sliding blocks connected to a corresponding one of said sliding members away from the central axis.
